(19) United States
(12) Patent Application Publication
(10) Pub. No.: US 2009/0100052 A1
(43) Pub. Date: Apr. 16, 2009

(54) ENABLING COLLABORATIVE NETWORKS

(76) Inventors: Edith H. Stern, Yorktown Heights, NY (US); Patrick J. O'Sullivan, Dublin (IE); Robert C. Weir, Westford, MA (US); Barry E. Willner, Briarcliff Manor, NY (US)

Correspondence Address: MOORE & VAN ALLEN, PLLC For IBM, P.O. Box 13706, Research Triangle Park, NC, 27709, US

(21) Appl. No.: 11/873,114

(22) Filed: Oct. 16, 2007

(51) Int. Cl. G06F 17/30; G06F 15/16

(52) U.S. Cl. 707/6; 709/206; 707/E17.017

(57) ABSTRACT

A system and method for providing collaborative resources to a user. A search expression is received from a user. One more keywords are determined from the search expression. One or more resources are determined responsive to the keywords and based on information related to the user, and the at least one resource is provided to the user. The one or more resources may be determined responsive to and prioritized to at least one of, for example, information in email of the user, an organization of the user, a search history of the user, an organizational position of the user, a level of experience of the user, a geographical location of the user, a geographical location of the resource, a language preference of the user, or a keyword match confidence. The resource may include at least one person and presence information associated with the at least one person.

### BACKGROUND OF THE INVENTION

The present invention is related to searching, and more specifically to enabling collaborative networks in response to searching.

Today, the ubiquity and efficiency of the Internet has fueled several interesting social phenomena. First, is the feeling of information entitlement. Search engines allow us all to be experts on the world series of 1931, as well as the most current headlines. Secondly, is the employment of collaborative approaches to what formerly were more solitary pursuits. With email, instant messaging and social networks, individuals share their hobbies, whereabouts, and innermost secrets. Enterprises use these tools to increase productivity.

An example: today, if you search a topic on a corporate internal homepage, you may receive a very useful page with (1) citations and links on one side of the page, (2) pages bookmarked by employees on the right, (3) relevant forums, blogs and wikis on the right, and (4) employee directory matches on the right. However, everyone who requests the search receives the same page. The references may contain pointers to individuals organizationally and geographically distant, when equally useful contacts could be found in the same time zone. The references may be to high ranked executives unavailable for discussion. Further, to establish contact, additional steps must be taken. Time consuming directory lookups on each individual must be made. In order to make instant messaging contact, one may need to add the individual to a buddy list, or interact with the directory page (e.g., sign in to see instant messaging status). Some directory pages do not offer presence information, even with interaction. There is no method to provide appropriate social network options responsive to the search, without further action.

### BRIEF SUMMARY OF THE INVENTION

According to one aspect of the present invention, a method for providing collaborative resources includes receiving a search expression from a user, determining at least one keyword from the search expression, determining at least one resource responsive to the at least one keyword and based on information related to the user, and providing the at least one resource to the user.

According to another aspect of the present invention, a system for providing collaborative resources includes at least one workstation, a keyword extractor, a search engine, a network, the search engine, the at least one workstation and the keyword extractor being operatively connected to the network, wherein a search expression is generated from a user at the at least one workstation, at least one keyword is extracted by the keyword extractor from the search expression, and at least one resource responsive to the at least one keyword and based on information related to the user is determined and provided to the user.

According to a further aspect of the present invention, a system for providing collaborative resources includes a first subsystem, at least one second subsystem, and a network, the first subsystem and the at least one second subsystem being operatively connected to the network, wherein in the first subsystem, at least one keyword is extracted from the search expression, and at least one resource responsive to the at least one keyword and based on information related to the user is determined and provided to the user, the at least one resource being obtained from at least one of the network, the first subsystem or the at least one second subsystem.

According to a still further aspect of the present invention, a network device for providing collaborative resources includes a network interface, the network interface operatively connected to a network and receiving information comprising a search expression from a user, a processor, the processor controlling an extraction from the search expression of at least one keyword and gathering at least one resource responsive to the at least one keyword and based on information related to the user, the processor providing the at least one resource to the user over the network.

According to an aspect of the present invention, a computer program product comprising a computer useable medium having computer useable program code embodied therewith, the computer useable program code comprising computer useable program code configured to receive a search expression from a user, computer useable program code configured to determine at least one keyword from the search expression, computer useable program code configured to determine at least one resource responsive to the at least one keyword and based on information related to the user, and computer useable program code configured to provide the at least one resource to the user.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a system for providing collaborative resources according to an example embodiment of the present invention;

FIG. 2 is a flowchart of a process for providing collaborative resources according to an example embodiment of the present invention;

FIG. 3 is a flowchart of a process for determining collaborative resources according to an example embodiment of the present invention; and

FIG. 4 is a system for providing collaborative resources according to another example embodiment of the present invention.

### DETAILED DESCRIPTION OF THE INVENTION

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments according to the present invention enable collaborative networks to be of more use, by creating and presenting networks appropriate to the user through interpreting cues from a search, optionally with context from additional sources. According to embodiments of the present invention, a representation of a social network may be provided in addition to the search results, for example, with an active buddy list of appropriate contacts. The contacts may be determined not only from the search argument but, may also be selected or prioritized responsive to several criteria such as, for example, the searcher's email, the searchers organization, a search history, a searcher's organizational position, a searcher's experience, or other information about the searcher such as a buddy list, geography, language preference, etc. Regarding the searcher's email, e.g., this may include those who have had correspondence including the searched topic. Further these may be selectively prioritized, that is they may show up higher in the buddy list than those that are not referenced in address book or email.

Regarding the searchers organization, e.g., organizational knowledge allows embodiments according to the present invention to selectively prioritize the collaborative resource list—e.g., place higher priority in the collaborative resource list on individuals from the same organization. Regarding the search history, e.g., those who repeatedly search on art related topics may receive a collaborative resource list of local art organizations (e.g., receptionist, secretary, etc.) with a click to call option. Regarding organizational position, e.g., VP searchers may receive a collaborative resource list of VP buddies whereas non executive searchers do not. Regarding experience, e.g., a new hire searching on “Java” may receive a collaborative resource list of individuals with several years experience (e.g., not VPs or 30 year company veterans). The information about the searcher may be used to select and present individuals/potential collaborators in a list such as, e.g., a buddy list or contact list. Embodiments according to the present invention allow the searcher to see not only citations and blog pointers, but also an active and inviting list of potential collaborators, selected with a bias towards those deemed most suitable for the searcher to work with.

Keywords may be selected from a search string by any of many methods. For example, natural language techniques can be employed, or algorithms as simple as selecting capitalized words or acronyms can be employed. Further, alternate keywords may be determined to improve the search. For example: a search on “WSDM”, may determine as alternate keywords “Web Services Distributed Management”, “MUWS” (Management Using Web Services), “MOWS” (Management Of Web Services), etc. Moreover, according to embodiments of the present invention, additional or supplemental keywords may be selected from previous searches. For example, a searcher may be looking into disruptive network technologies. A first search may be on “WIMAX”. A second search may be on “MANET”. This may yield additional keywords such as “network technologies” or “networking”. These additional keywords may be too broad if “WIMAX” was the only search launched. However, as additional searches are launched, these phrases may become more useful in determining potential collaboration opportunities.

The process of determining one or more collaborators that may be included in a list to the searcher may include examining emails of the searcher for candidates, examining directories for keyword associations, web page analysis, use of hierarchy filters, profile analysis, etc. For example, regarding examining emails of the searcher for indications of suitable candidates, these emails may be previously indexed or the examination may be done at the time of the search. The emails may be examined locally or centrally at a mail server, or at an intermediate server that has access to both the search term and the searcher's emails. Once the keyword is located in a piece of email, candidate individuals/collaborators may be identified. These may include the sender of the email, others copied on the email, or others mentioned within the email. Candidates may be selected from the structured “to:” and “cc:” fields, as well as by performing natural language examinations of the text within the email. Other techniques may include, for example, searching pictures or other images, and selecting candidates based on image annotations, face recognition, extraction of text from the image (e.g., reading identification badges on an individual captured in a conference photo).

Regarding examining directories for keyword associations, embodiments according to the present invention may include evaluations of organizational distance. In some embodiments, candidates may be selected only from within the organization. In other embodiments encouraging cross-unit collaboration, candidates may be selected only from outside the organization. According to embodiments of the present invention, directories may be examined for all primary and alternate keywords.

Regarding web page analysis, this may be particularly useful in consumer applications. For instance, a consumer that initiates a search on “knitting” may be well served by selection of candidates that mention knitting in their web pages or blogs (i.e., online hosted chat room usually devoted to a specific subject discussed by the host).

Hierarchy filters may be used for selection of candidates based on rank, title, or position of the searcher. For example, the results of a search where the searcher is a vice president of sales may result in some of the candidates selected (based on the search criteria and other factors) also being vice presidents (e.g., VP of sales, VP of marketing, etc.).

Regarding profile analysis, analysis of both the searcher and candidate collaborators' profiles may be used in the selection of candidates. In an enterprise environment where experience and other information is available, embodiments according to the present invention may include the selection of a candidate collaborator within pre-specified seniority bands, language preferences, geographies, and so on.

In addition, according to embodiments of the present invention, users may be ordered based on predetermined criteria such as, for example, organizational distance (e.g., candidates may be presented first who are members of the same organization), collaborative distance (e.g., email correspondents may be presented first), keyword match confidence (e.g., if the original search was WIMAX and the candidate matches “wireless”, then the confidence level is lower than it would be for candidates with a full WIMAX match), etc.

Moreover, according to embodiments of the present invention, presence information about resource persons/users may be displayed. Presence information relates to whether a person is online or otherwise currently available (e.g., user may be called now, emailed now, or may be sent an Instant Message (IM)). For example, in one embodiment only those persons or users with “available” active presence may be listed. In other embodiments the top N candidate resource persons/users may be listed regardless of presence status. In yet other embodiments, those with collaborative or other closeness may always be listed, and the remaining candidates listed only if their status indicates that they are available. Click-to-call options make this very useful to promote synchronous communication.

Embodiments according to the present invention may increase the amount of “ad hoc” requests, i.e., a user may determine that another person previously unknown to him is a source of information and send an instant message to that person. Thus, ad hoc requests where the receiver is not personally known to the sender may greatly increase. In an instant message profile a user can state if he welcomes ad hoc requests and is friendly towards them. The information may be communicated to the sender during presence awareness (or by right clicking and choosing). A user may decide only to send ad hoc queries to those that have indicated they are friendly towards them. This may be extended so that the user may also indicate a list of topics on which he would be willing to receive ad hoc queries. According to embodiments of the present invention, this may be used in the selection of potential collaborators, indicated as part of the presentation of the list of potential collaborators, or both.

When an instant message is sent the searcher/user may indicate if it is ad hoc. At the end of the exchange the user may indicate if the exchange is satisfactory. The inventive system may keep a database on the receivers of ad hoc requests and how many exchanges were satisfactory and how many were not. The sender of an ad hoc instant message may also access this information at the time of viewing the list of collaborative resources, (or by right clicking). Further, a user may only want to send messages to those with proven track records of satisfactory responses. Presence information may be obtained through corporate or consumer presence services, such as, for example, IBM Lotus®, Sametime® Instant Messenger, AOL® Instant Messenger (AIM), MSN Instant Messenger™, Yahoo Instant Messenger™, etc.

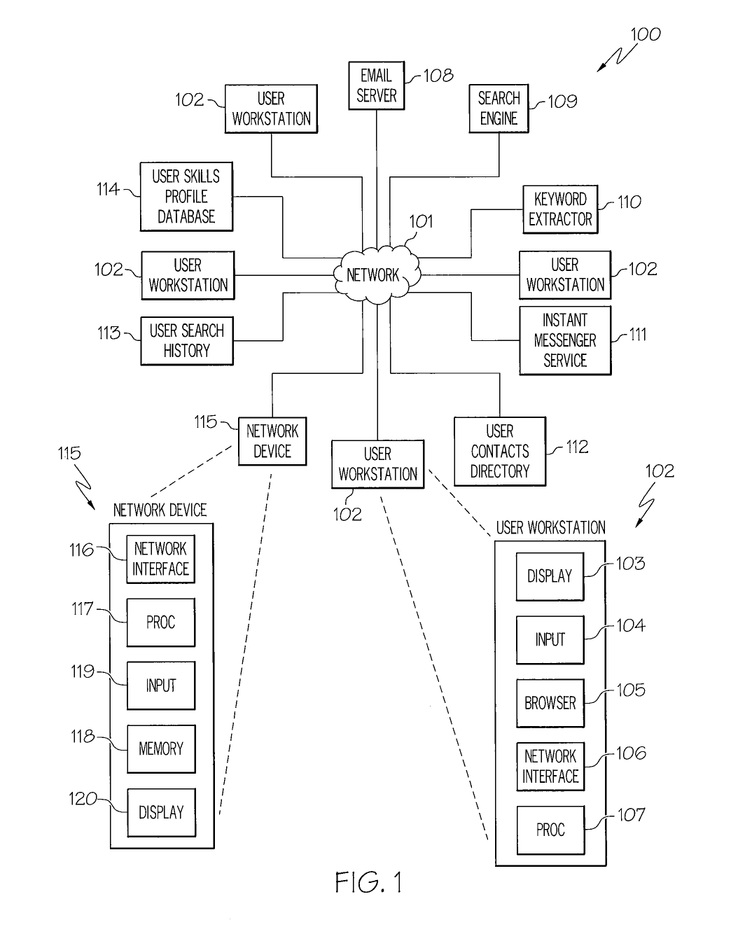

FIG. 1 shows a system for providing collaborative resources according to an example embodiment of the present invention. The system 100 may include a network 101 that has various devices or functional elements operatively attached such as, for example, one or more user workstations 102, an email server 108, a search engine 109, a keyword extractor 110, an instant messenger service 111, a user contacts directory 112, one or more network devices 115, a user skills profile database 114, or a user search history 113. Each network device 115 may include a number of elements such as, for example, a network interface 116, a processing device 117, a memory 118, an input device 119, a display device 120, etc. Further, each user workstation 102 may include various elements such as, for example, a display 103, an input device 104 (e.g., keyboard, mouse, etc.), a browser 105, memory 106, and a processing device 107.

According to embodiments of the present invention, a user at a user workstation 102 may enter a search expression or term using an input device 104. A network device 115 may receive the search expression from the user workstation 102 via the network 101. The network device 115 may then perform one or more of various tasks related to the user and the search expression. For example, the network device 115 may access a user skills profile database 114 to identify what skills the user may possess. The user skills profile database may have information on a plurality of users such as job title, experience, years of employment, current position, current location, age, etc. The network device 115 may use information gathered about the user from the user skills profile database 114 in combination with the search expression entered by the user in order to identify resources to be provided to the user in response to the search expression.

Moreover, the network device 115 may access a user search history 113 to identify past searches performed by the user. The history of past searches performed by the user may also be used by the network device 115 along with the search expression to identify resources to be provided to the user in response to the search expression.

The network device 115 may also access an email server 108 via the network 101 to identify emails that have been sent or received by the user. The network device 115 may identify persons associated with these emails other than the user, as well as information on the subject matter of the emails, information about the senders or receivers, or other information. The network device 115 may use information gathered from the email server 108 related to the user in combination with the search expression to identify resources to be provided to the user in response to the search expression.

In addition, the network device 115 may access a user contacts directory 112 via the network 101 to identify contacts of the user providing the search expression. The user contacts directory 112 may contain various information regarding contacts known by the user such as name, address, location, title, current job description, current company, etc. The network device 115 may use information from the user contacts directory 112 in combination with the search expression to identify resources to be provided to the user based on the search expression.

Moreover, the search expression may be provided to a keyword extractor 110 that may identify and extract one or more keywords from the search expression. These keywords may then be provided to the network device 115 and used in combination with other information gathered by the network device 115, as has been previously discussed, to identify resources to provide to the user in response to the search expression. Further, the network device 115 may use a search engine 109 to identify resources to be provided to the user in response to the search expression. To help illustrate embodiments of the present invention, functions may have been described these as separate, however a subset of these functions may reside in the same system. For example, the keyword extractor may reside in the network device, or may reside in the search engine system.

Once resources have been identified, these resources may be provided to the user via a user workstation 102. The user may then display the various resources provided to identify the resources that the user may want to further explore. In this regard, if resources are provided to the user that are one or more persons with knowledge of subject matter in the area of the keywords or search expression, the user may desire to contact these person resources. The person resources may be provided to the user along with information regarding whether they have an active presence (i.e., are accessible now via an instant message) or whether these persons have pre-defined criteria that must be met before they will receive ad hoc instant messages or contact from others. For example, if a resource is provided that is a person that has experience or other information related to the keyword and/or search expression, and the person resource is provided to the user with an indication of an active presence, the user may send this person resource an instant message using a user workstation 102, the network 101, and an instant messenger service 111. Therefore, according to embodiments of the present invention, a user may immediately contact persons (one or more) via an instant messenger service to obtain real-time and immediate information related to a search expression.

Moreover, since the resources provided to the user may be related not only to the search expression but also to information related to the user, the person resources contacted by the user may have something in common with the user, such as same job title, same level of experience, same company, same age, same geographical location, etc. Further, according to embodiments of the present invention, persons provided as resources may also be provided with information related to whether the person receives ad hoc messages or whether ad hoc messages may only be received by the persons if the ad hoc messages relate to a particular subject matter or topic. In this regard, a user may only contact a person that may be provided as a resource in response to the search expression, only if the person resource accepts ad hoc communications in general or accepts ad hoc communications for subjects or topics related to the search expression entered by the user.

The network 101 may be a network located within a company or enterprise such as an intranet, or may be a private network or other type network of one or more companies. Further, the network 101 may be an internal network shared by one company over multiple geographical locations. In addition, network 101 may be the Internet.

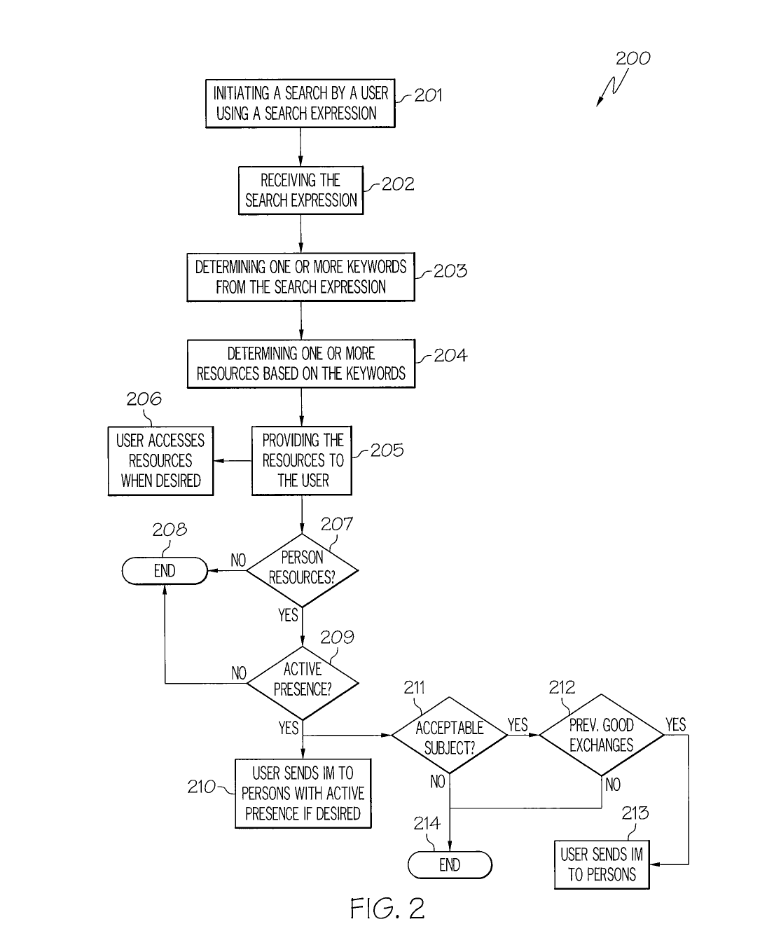

FIG. 2 shows a flowchart of a process for providing collaborative resources according to an example embodiment of the present invention. In the process 200, in block 201, a search may be initiated by a user using a search expression. In block 202, the search expression may be received. In block 203, one or more keywords may be determined from the search expression. In block 204, one or more resources may be determined based on the keywords. The resources may be determined based on the keywords and information related to the user. In block 205, the resources may be provided to the user. In block 206, the user may access the resources when desired. In this regard, the resources may be any kind of information source such as, for example, links to websites, links to information such as text, video, audio, blogs, or live persons.

In block 207, it may be determined if any of the resources provided to the user are persons, and if not, in block 208 the process ends. If one or more of the resources provided to the user are persons, in block 209, it may be determined whether the one or more persons have an active presence, and if not, in block 208 the process ends. If one or more of the persons have an active presence, if there are no conditions associated with the persons with the active presence, in block 210, the user may send an instant message to the persons with an active presence if the user desires. In block 211, it may be determined whether the search expression contains subject matter that is acceptable to persons with an active presence for allowing instant messages to the persons, and if not, in block 214 the process ends. If the subject matter acceptable to the persons with active presence is the same as or related to subject matter in the search expression, in block 212, the user may determine if the other users have had previous good exchanges with the persons with the active presence, and if not, in block 214 the process ends. If in block 212, other users have had previous good exchanges with the persons with active presence, then in block 213, the user may send an instant message to these persons. In this regard, a status, for example, successful, failure, good, bad, etc., may be determined after past IM exchanges with the user and other persons and stored.

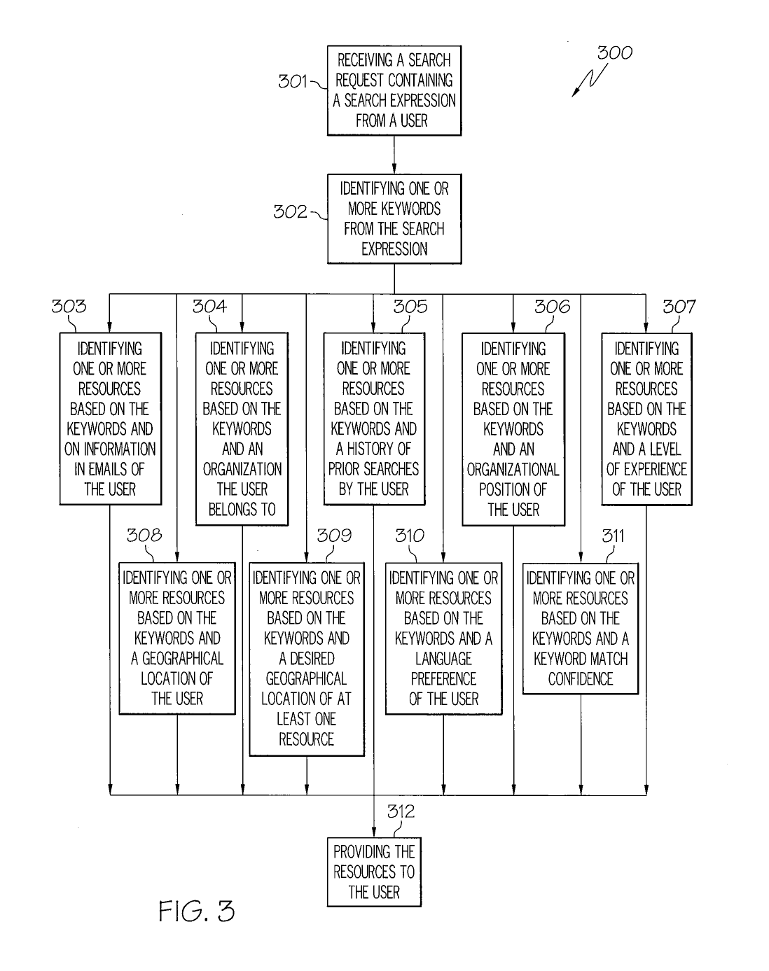

FIG. 3 shows a flowchart of a process for determining collaborative resources according to an example embodiment of the present invention. In the process 300, in block 301, a search request may be received containing a search expression from the user. In block 302, one or more keywords may be identified from the search expression. Then, one or more of various activities may occur as described in blocks 303-311. For example, in block 303, one or more resources may be identified based on the keywords and on information in emails of the user. Further, in block 304, one or more resources may be identified based on the keywords and an organization that the user belongs to. In addition, in block 305, one or more resources may be identified based on the keywords and a history of prior searches by the user.

Moreover, in block 306, one or more resources may be identified based on the keywords and on an organizational position of the user. For example, if the user is a vice-president, resources may be identified of persons that are also vice-presidents. In block 307, one or more resources may be identified based on the keywords and on a level of experience of the user. For example, if the user has six years of experience in telecommunications, resources of persons with comparable experience in telecommunications may be identified.

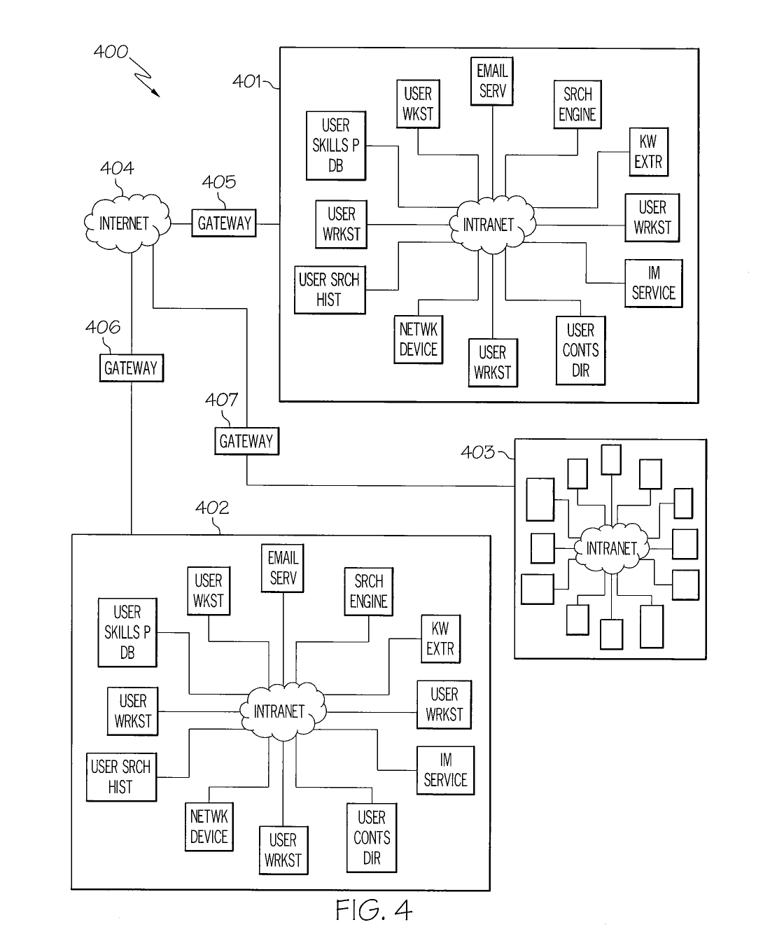

FIG. 4 shows a system for providing collaborative resources according to another example embodiment of the present invention. The system 400 may include one or more subsystems 401, 402, 403 that may be interconnected to each other via one or more gateways 405, 406, 407, and the Internet 404. Each of the subsystems 401, 402, 403 may include elements the same as or similar to those shown previously in FIG. 1. A user at a user workstation in any of the subsystems 401, 402, 403 may enter search criteria where a network device at any of the subsystems 401, 402, 403 or a network device connected to the Internet 404 may identify resources in response to the search criteria and provide these resources to the user at the user workstation. In this regard, resources may be identified from any of the subsystems 401, 402, 403 as well as from entities connected to the Internet 404. Each of the subsystems 401, 402, 403 may be an intranet within a specific company, a private network of one or more companies, or any other type of network. Further, although each of these subsystems 401-403 are shown with similar entities, the entities in each subsystem 401-403 may be the same or may be completely different. Further, network 404 may not be the Internet but be any other type network and be within the scope of the present invention. Therefore, according to embodiments of the present invention, a user at a workstation in one subsystem may enter search criteria and receive resources in response to the search criteria from a plurality of different subsystems or entities attached to various networks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for providing collaborative resources comprising:
receiving a search expression from a user;
determining at least one keyword from the search expression;
determining at least one resource responsive to the at least one keyword and responsive to information related to the user; and
providing an indication of the at least one resource to the user.

2. The method according to claim 1, further comprising the indication of at least one resource comprising contact information for at least one person and providing presence information associated with the at least one person to the user.

3. The method according to claim 2, further comprising providing an indication of resources to the user comprising only the at least one person having active presence information.

4. The method according to claim 1, further comprising determining the at least one resource responsive to at least one of information in email of the user, an organization of the user, a search history of the user, an organizational position of the user, a level of experience of the user, a geographical location of the user, a geographical location of the at least one resource, a language preference of the user, or a keyword match confidence.

5. The method according to claim 1, further comprising determining the at least one resource responsive to at least one second keyword in information in email of the user.

6. The method according to claim 1, further comprising providing to the user the at least one resource responsive to at least one of information in email of the user, the organization of the user, the search history of the user, the organizational position of the user, the level of experience of the user, the geographical location of the user, the geographical location of the at least one resource, the language preference of the user.

7. The method according to claim 1, further comprising determining at least one resource comprising contact information and presence information for at least one person, the presence information comprising whether the at least one person is receptive to ad hoc requests.

8. The method according to claim 1, further comprising determining at least one resource comprising presence information for at least one person, the presence information comprising subjects the at least one person is receptive to receiving ad hoc requests for.

9. The method according to claim 1, further comprising determining at least one resource comprising contact information and presence information for at least one person.

10. The method according to claim 9, further comprising receiving an instant message from the user directed to the at least one resource.

11. The method according to claim 9, further comprising indicating whether a previous exchange during an instant message with the at least one person was satisfactory.

12. The method according to claim 11, further comprising sending instant messages by the user only to at least one persons having a record of satisfactory exchanges.

13. The method according to claim 1, further comprising extracting the at least one keyword from the search expression in a first subsystem, and determining the at least one resource from at least one of a network, the first subsystem or at least one second subsystem, the first subsystem and the at least one second subsystem being operatively connected to the network.

14. The method according to claim 1, further comprising receiving the search expression from the user at a network device, the network device determining the at least one keyword from the search expression, determining the at least one resource responsive to the at least one keyword and responsive to information related to the user, and providing the indication of the at least one resource to the user.

15. A method for providing collaborative resources comprising:
receiving a keyword and information related to a user;
determining at least one resource responsive to the at least one keyword and responsive to the information related to the user; and
providing contact information for at least one person and providing presence information associated with the at least one person to the user.

16. The method according to claim 15, further comprising determining the at least one resource responsive to at least one of information in email of the user, an organization of the user, a search history of the user, an organizational position of the user, a level of experience of the user, a geographical location of the user, a geographical location of the at least one resource, a language preference of the user, or a keyword match confidence.

17. The method according to claim 15, further comprising determining the at least one resource responsive to at least one second keyword in information in email of the user.

18. The method according to claim 15, further comprising the presence information comprising whether the at least one person is receptive to ad hoc requests.

19. The method according to claim 15, further comprising the presence information comprising subjects the at least one person is receptive to receiving ad hoc requests for.
